(19) United States
(12) Patent Application Publication
(10) Pub. No.: US 2024/0160045 A1
(43) Pub. Date: May 16, 2024

(54) ELECTROACTIVE OPHTHALMIC LENS WITH SHAPE MEMORY ALLOY COMPONENT

(71) Applicant: Atheneum Optical Sciences, LLC, Orange Park, FL (US)

(72) Inventor: Randall Pugh, Jacksonville, FL (US)

(73) Assignee: Atheneum Optical Sciences, LLC, Orange Park, FL (US)

(21) Appl. No.: 18/384,817

(22) Filed: Oct. 27, 2023

Related U.S. Application Data
(60) Provisional application No. 63/425,220, filed on Nov. 14, 2022.

(51) Int. Cl. G02C 7/08; G02C 7/04

(52) U.S. Cl. CPC G02C 7/081; G02C 7/04

(57) ABSTRACT

Electroactive dynamic lenses that have more than one degree of visual accommodation that supplements an accommodation provided by a human eye on which the electroactive dynamic lens is worn. The accommodation is provided via activation of a shape memory alloy structure through a transition. A desired change in a focal plane may be accomplished with structures that may be electroactively controlled to expand or contract during a transition of the shape memory alloy. In some embodiments, a ring containing one or more elements that expand or contract under the influence of an electrical current to modify an overall shape of a formable ophthalmic lens and accomplish visual accommodation.

### CROSS REFERENCE TO RELATED APPLICATIONS

This application claims the benefit of U.S. Provisional Patent Application No. 63/425,220 filed Nov. 14, 2022, the entire disclosure of which is incorporated herein by reference.

This application cross-references U.S. patent application Ser. No. 17/984,103, filed Nov. 9, 2022, the entire contents of which are incorporated herein by reference. This application also cross-references U.S. patent application Ser. No. 18/235,586, filed Aug. 18, 2023, the entire contents of which are incorporated herein by reference.

### FIELD OF THE INVENTION

The present invention relates to methods and associated apparatus and devices which relate to an energized biomedical device. More specifically, the present invention includes an electroactive biomedical device ophthalmic lens capable of changing shape.

### BACKGROUND OF THE INVENTION

Most of the human population becomes presbyopic as they age. Use of static lenses, such as contact lenses or spectacle lenses may assist a patient, but they do not replicate the eye's natural ability to dynamically change focus. Recently, there have been some disclosures on how to incorporate active optical components into a contact lens. However, the designs are not able to be reliably manufactured or manufactured on a scale suitable to address the needs of the population. In addition, some of the previously known designs include deleterious effects from an electroactive optical structure spanning the optic zone.

### SUMMARY OF THE INVENTION

Accordingly, methods and apparatus for an electroactive contact lens without significant structure located in an optic zone of an ophthalmic lens are described herein. The present invention provides methods and apparatus for providing ophthalmic lenses with one or more functionalities included in the ophthalmic lens and a controlled change in optical characteristic of an ophthalmic lens; or other change in a shape of another biomedical device. In some embodiments, the formed ophthalmic lens includes a change in shape based upon an electric current passed through a shape memory alloy to operate without significant structure located in the optic zone an optic zone of the ophthalmic lens.

In some examples an electroactive ophthalmic lens (or other article) may be formed including a hydrogel mass of a size and shape for placing on an eye of a patient. The hydrogel mass may include an optic zone with an optical characteristic for modifying vision of the patient. The ophthalmic lens may also include a shape memory alloy structure supported in the hydrogel mass outside of the optic zone. The ophthalmic lens may also include a power source in electrical communication with the shape memory alloy structure.

In some examples, the electroactive ophthalmic lens may also include a holding structure supporting the shape memory alloy structure within the hydrogel mass outside of the optic zone. There may be examples of the ophthalmic lens, wherein the power source is capable of supplying sufficient power to the shape memory alloy structure to cause the shape memory alloy structure to change state. In some examples, the electroactive ophthalmic lens may additionally include control electronics operative to cause the power source to supply power to the shape memory alloy structure.

In some examples, the electroactive ophthalmic lens may additionally include a communications device operative to wirelessly receive a command to have the control electronics operative cause the power source to supply power to the shape memory alloy structure. In some cases, the electroactive ophthalmic lens may additionally include a first power conductor placing the power source in electrical communication with the shape memory alloy structure. The electroactive ophthalmic lens may additionally include a second power conductor placing the power source in electrical communication with the shape memory alloy structure.

There may be some examples of the electroactive ophthalmic lens wherein the shape memory alloy structure comprises a first wire comprising nitinol. The electroactive ophthalmic may include examples where the shape memory alloy structure comprises at least a second wire comprising nitinol with a difference of one or more of size or shape compared with the first wire comprising nitinol.

According to the present disclosure there may be examples of methods of forming an electroactive ophthalmic lens which may include one or more of the following steps. The method may include forming a shape memory alloy structure insert with a size and shape capable of being embedded in a contact lens without obscuring an optic zone of an ophthalmic lens. The method may include fixedly attaching multiple holding structures to the shape memory alloy structure insert. The method may include placing the shape memory alloy structure insert in electrical communication with a power source. The method may include embedding the shape memory alloy structure insert, the holding structures, and the power source within hydrogel comprising the ophthalmic lens.

In some examples the methods may also include a step of embedding an electronic controller within the hydrogel comprising the ophthalmic lens, where the electronic controller may be operative to cause the power source to supply electrical power to the shape memory alloy structure insert. The methods may also include a step of embedding a communications device in the hydrogel comprising the ophthalmic lens, where the communications device may be operative to receive a wireless communication comprising a command to operate the electronic controller to cause the power source to supply electrical power to the shape memory alloy structure insert.

In some examples, the methods may include examples wherein the shape memory alloy structure comprises a first wire comprising nitinol. In some examples, the methods may include examples wherein the shape memory alloy structure comprises at least a second wire comprising nitinol with a difference of one or more of size or shape compared with the first wire comprising nitinol.

In some examples, there may be methods of forming an ophthalmic lens which may include one or more of the following steps. In some examples, the method may include wrapping a quantity of a shape memory alloy wire around a forming mandrel. The methods may include performing a heat treatment on the nitinol wire to program a shape of the forming mandrel to the shape memory alloy wire. The methods may include cooling the shape memory alloy wire below a transition temperature of the shape memory alloy wire. The methods may include stretching the shape memory alloy wire. The methods may include attaching one or more attachment features upon the shape memory alloy wire. The methods may include forming a lens body with a cavity. The methods may include placing the shape memory alloy wire within the cavity of the lens body. In some examples, the methods may include sealing the cavity to form the ophthalmic lens.

The methods may include examples wherein the shape memory allow is comprised of nitinol. The methods may include placing an electronic controller and an energy source in logical communication with the shape memory alloy wire. The methods may include examples including receiving a signal in the ophthalmic lens comprising the shape memory alloy wire, the electronic controller, and the energy source, wherein the receiving of the signal causes the electronic controller to flow electricity through one of the shape memory allow wire or an insulated wire wrapped around the shape memory allow wire.

In some examples, the methods may include examples wherein the flow of electricity heats the shape memory alloy wire and causes a change in an optical state of the ophthalmic lens. In some examples, the methods may include placing at least a second heat treated shape memory alloy wire within the cavity of the lens body.

There may be examples of methods of use of the apparatus as described herein that include one or more of the following steps. The methods may include placing an ophthalmic device comprising the various aspects as described herein upon an eye of a user. In some methods, the user may activate the electronic controller. In some methods, the user may communicate a signal to communication means within the electronics of the ophthalmic device to engage the controller to flow current through or around a shape memory component within the ophthalmic device. In some examples, a change of state of the optical aspects of the ophthalmic device may be caused by the communication of signals by the user of the ophthalmic device.

### BRIEF DESCRIPTION OF THE DRAWINGS

The accompanying drawings, which are incorporated in and constitute a part of this specification, illustrate several embodiments of the invention and, together with the description, serve to explain the principles of the invention:

FIG. 1 is an illustration of an ophthalmic lens including a shape memory alloy structure.

FIG. 2 is an exemplary cross section depicting an effect of an embedded shape memory alloy structure on the shape of the lens.

FIG. 3 depicts an exemplary process flow chart of an ophthalmic lens including a shape memory alloy wire structure.

FIG. 4 depicts an alternative exemplary process flow chart of an ophthalmic lens including a shape memory alloy wire structure.

FIG. 5 illustrates an exemplary multiple shape memory alloy wire ring structure.

FIGS. 6A and 6B illustrate exemplary aspects of holding structures.

FIGS. 6C-6E illustrate exemplary aspects of holding structures with more than one shape memory alloy wire.

FIG. 7 illustrates an exemplary energized ophthalmic lens including a shape memory alloy based structure.

FIG. 8 illustrates various embodiments of nitinol that may be included in an ophthalmic lens.

### DETAILED DESCRIPTION OF THE INVENTION

Image accommodation at disparate distances is provided with an ophthalmic lens interposing a lens between an item being viewed and a user's eye, a shape of the ophthalmic lens may be modified to change focal aspects of the ophthalmic lens. The dynamic lens of the present invention mimics a natural lens of a young human that accomplishes vision accommodation (change focus) in a dynamic manner with muscles that create forces on a natural lens body in the human eye. The forces created by the muscles are distributed from muscle bodies through zonules to a lens capsule. Zonule fibers tighten and pull the lens for near vision. When the eye muscles relax upon the zonules, the surface of the lens may flatten, which moves the focal plane towards distance vision. Essentially, the human body adjusts the dynamic lens of the human eye to move a focus in a first direction upon a constriction of the muscles, move the focal plane in another direction when the muscles relax. As a human ages, their ability of their eye muscles to move the zonules and change a focal plane provided by the human eye lens is decreased, in part due to a thickening of the lens. The present invention provides for electroactive dynamic lenses that have more than one degree of visual accommodation that supplements any accommodation provided by a human eye on which the electroactive dynamic lens is worn.

According to the present disclosure, a desired change in a focal plane may be accomplished with an electroactive dynamic ophthalmic lens. The dynamic lens includes electroactive activates structures that may be electroactively controlled to expand or contract. In some embodiments, a ring contains one or more elements that expand or contract under the influence of an electrical current to modify an overall shape of a formable ophthalmic lens and accomplish visual accommodation.

In some embodiments, one or more shape memory alloys may be included in a structural element that responds to electrical current to induce pressure stresses in a body of an ophthalmic lens and change a focal characteristics of the ophthalmic lens.

Various embodiments of ophthalmic lenses with electroactive components are described herein in detail. It is noted that while the examples discussed herein generally describe lenses with one or more electroactive components that include shape memory alloys, other materials that are capable of electroactively controlled expansion, contraction, or other change in shape based upon electric power, such as, in non-limiting examples, piezoceramics and electroactive polymers are also within the scope of the present invention.

Shape Memory Alloys

As referred to herein, a shape-memory alloy includes an alloy that may be deformed when maintained at a first temperature and return to a pre-deformation shape when it is transitioned to a second temperature. In some preferred embodiments, the shape memory alloys used in components included in an electroactive ophthalmic lens are deformed at a relatively lower temperature (colder temperature) and returned to a pre-deformation shape at a relatively higher temperature (heated temperature). A change in temperature may be accomplished via application of an electrical current through the shape memory alloy. Devices formed of shape-memory alloys for insertion into an ophthalmic lens are relatively lighter weight, solid-state alternatives to other actuators such as liquid meniscus lens systems.

In some embodiments, an exemplary shape memory alloy, Nitinol may be formed into a round or oval shape which may be embedded within an ophthalmic lens body made of a silicone material base for example. Nitinol alloys may be formed of varying amounts of constituent compounds at least including both Nickel and Titanium and may be tailored to have a particular transition temperature in various ranges. In a particular example, Nitinol wire, such as that available from Nexmetal Corporation, may be configured to have a transition temperature of 40 C, which is very close but higher than a normal human body temperature. An electrical current is used to heat the wire above 40 C wherein the Nitinol will be in the high temperature or austenitic phase and become more dense and shrink its volume. Nevertheless, Nitinol may be stretched in the martensite phase or low temperature phase by as much as 8% or more.

In some examples, heating may be removed by the termination of an electrical current flow through a wire. When the heating is removed the temperature of the Nitinol wire may decrease beneath the transition temperature as the lens cools to a temperature less than the transition temperature and the Nitinol will be in the low temperature or martensite phase. At the low temperature phase, the Nitinol wire will be subjected to the elastic forces of the lens body which it had been formed to and resume the shape into which it was originally formed.

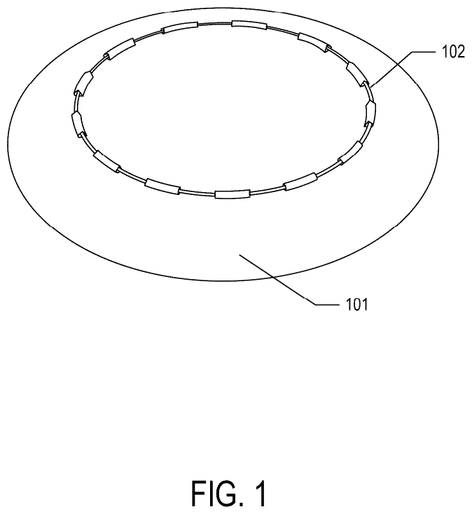

Referring to FIG. 1, an exemplary Nitinol based structure 101 is illustrated embedded within an ophthalmic lens body 102. The illustrated shape may be described as a circular annulus, however other shapes of the Nitinol structure may be used. In some examples, electrical current may be used to heat the Nitinol wire structure to a temperature above the transition temperature. When this occurs the Nitinol wire structure contracts. As the electrical current is cut off, the wire temperature will return to a temperature beneath the transition temperature, and stresses inherent within the ophthalmic lens body may pull the lens back to its original state. Thus, an electroactive device with two states may be formed.

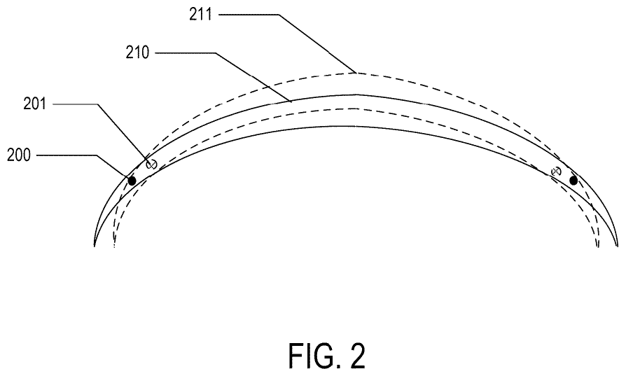

Referring to FIG. 2, an ophthalmic lens 200 with a nitinol insert 201A-B is illustrated with a lens surface 202A-B. When the temperature of the Nitinol insert 201A-B exceeds its transition temperature the Nitinol insert 201A-B transitions from a first state to a second state with a corresponding change in shape.

As illustrated, the Nitinol insert 201A is shown a relaxed state in a first position 203A and the Nitinol insert 201B is shown in a transitioned state at a second position 203B. Essentially, in this example, as the Nitinol insert 201A contracts from transition to become Nitinol wire 201B, a change in position from a first position 203A to w second position 203B forms an original ophthalmic lens surface 202A into an ophthalmic lens surface 202B with a different shape (illustrated with dashed lines). In some examples, a degree of curvature change may correspond to an effect when the Nitinol wire changes its length by 5% or more. 702

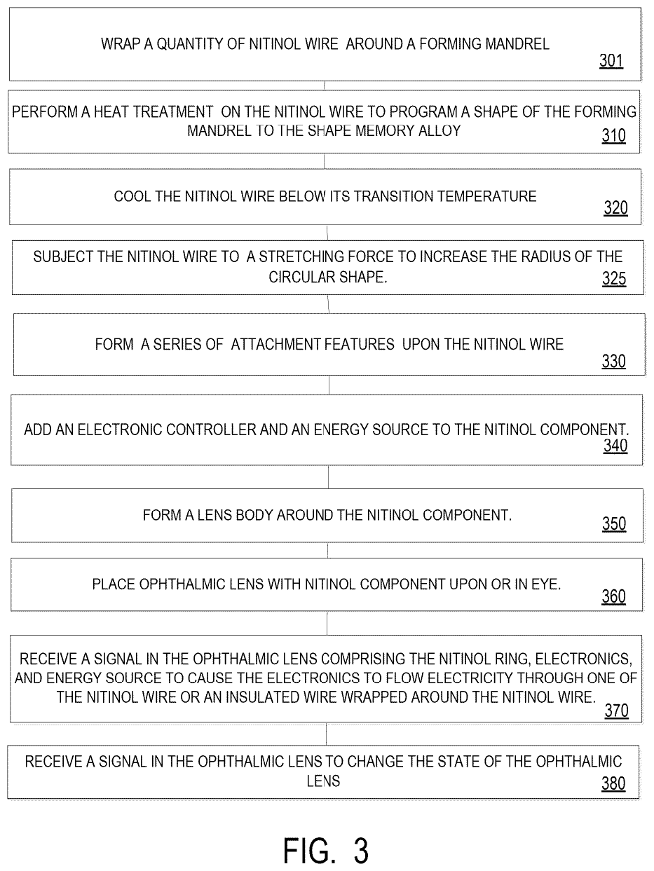

Referring to FIG. 3, an exemplary processing flow for an ophthalmic lens including a Nitinol ring element is found. At Step 301, a quantity of Nitinol wire is wrapped around a forming mandrel. In some examples, the forming mandrel may be shaped to form the wire into a circular shape. In some examples, a single strand of wire may be placed around the forming mandrel. In some examples, a preformed ring of wire may be placed where two ends of Nitinol may be welded together before being placed upon the mandrel. In other examples a joining of two ends may be performed upon the mandrel. In still further examples, the Nitinol may be wrapped around the mandrel without sealing two ends of the Nitinol. In some embodiments, the Nitinol may be later cut and/or the ends joined. The mandrel may have a circular shape or other shapes that, for example, may relate to a desire to add characteristics to address higher order optical aberrations than just a spherical shape. In some examples, wire may be wrapped around a number of mandrels at the same time. In some examples, fine Nitinol wire may be used and wrapped multiple times around each mandrel, such that the wire is a composite of multiple strands.

Proceeding to step 310, a heat treatment may be performed on the Nitinol wire. In some examples, the heat treatment may be performed in a controlled atmosphere such as in the absence of oxidizing or reducing elements including oxygen or hydrogen as non-limiting examples. Furthermore, the heat treatment may be performed with programmed ramping cycles. In some examples, the heat treatment may have a maximum temperature that is above 300 C. In some other examples, the heat treatment may have a maximum temperature that is 500 C. In further examples the heat treatment may have a maximum temperature at any value above 300 C. The heat treatment may occur for a time period of a few seconds. In other examples the heat treatment may occur for any time period more than a few seconds. In some examples, the Nitinol wire may be subjected to a quenching or rapid cooling process. In some examples, the heat treatment of step 310 may program a shape into the Nitinol material, which is the shape of the Nitinol around the mandrel may be locked in as the shape that the austenite phase may assume when temperature of the Nitinol is ramped above the transition temperature by some manner.

Proceeding to step 320 the Nitinol wire may be cooled below its transition temperature, and then at step 325 the Nitinol wire may be subjected to a stretching force to increase the radius of the circular shape. The stretching may be performed by the mandrel that the Nitinol wire was formed upon. In other examples the Nitinol ring may be stretched with a second fixture. In some examples the Nitinol wire may be stretched into a shape other than a circle.

At step 330 a series of attachment features may be formed upon the Nitinol wire. In this step, and subsequent steps, the Nitinol wire may be maintained at a temperature beneath a transition temperature of the Nitinol wire during processing so that it does not experience a phase change, and with the phase change, experience a corresponding change in shape.

At step 340 an electronic controller and an energy source may be added to the Nitinol component. In some examples, the electronic controller may be attached to two ends of the Nitinol wire so that current may be directed through the Nitinol wire itself to heat it above the transition temperature. In such examples, the wire ends may be joined at an insulator rather then being welded together. In another example a fine insulated wire may be wrapped around the Nitinol ring and the two ends may be connected to the electronic controller for heating. In some more advanced examples, multiple wire pairs may be formed to allow for independent activation of segments of the rings.

At step 350 a lens body may be formed. In some examples the lens body may be formed with the Nitinol component in place. In other examples, a lens body with a cavity may be formed into which the Nitinol component may be placed. The lens body may be formed by additive manufacturing processing as is described herein or in referenced discussions. In other examples, other manners of forming a lens body such as by molding may be used. Again, it may be important to maintain the temperature during any processing with the Nitinol element present at a temperature beneath the Nitinol alloy transition temperature.

At step 360, the Nitinol ring embedded in the contact lens, wherein the Nitinol exists below its transition temperature in a stretched state, is placed into the eye of a user.

At step 370, the contact lens including a Nitinol ring, electronics, and energy source may receive a control activation (e.g.; an analog or digital electrical energy pattern) which may be processed by the electronics and cause a flow electrical current through one or both of the Nitinol wire, and an insulated wire wrapped around the Nitinol wire. The flow of the electrical current causes a temperature of the Nitinol to raise from a first temperature below a transition temperature to a second temperature above the transition temperature of the Nitinol (or other shape memory alloy or electroactive material) and change a state of the Nitinol to a deformation memory shape. In some examples, the ring may contract in diameter which may cause ophthalmic lens material in which the Nitinol is embedded to change shape. The change in shape of the Nitinol may be designed to cause the ophthalmic lens material to change an arcuate shape of an optic zone (e.g., bow up in the middle) and cause the ophthalmic lens to focus on either a more distance focal plane or a nearer focal plane.

In some examples of the present invention, a temperature of a shape memory alloy may be maintained above a transition temperature of the shape memory, and preferably at a constant temperature. The constant temperature may be maintained by measuring a temperature at or near the shape memory alloy with a temperature sensing device (such as, by way of non-limiting example, a thermocouple, transducer, or other temperature measurement device). In some other examples, a resistance of a conductor (e.g., a wire) used for heating (either the Nitinol or an insulating wrapped wire) may be measured by the electronics and used to determine the temperature. Feedback of a temperature measurement may be used to hold the temperature of the shape memory allow above the transition temperature by the application of electrical current, or diminishing of an electrical current flowing through the conductor to bring the shape memory allow to a desired temperature range and/or maintain a desired temperature range. In some embodiments, in order to efficiently manage available electrical energy, a temperature of the shape memory alloy may be controlled at a temperature as close to, but above the transition temperature as possible.

At step 380, a signal may be transferred to the electronics to signal the electronics to change the state of the ophthalmic lens. The flow of current may be stopped in the wire, and the temperature may decrease to a temperature beneath the transition temperature of the Nitinol wire. When that happens the physical state of the Nitinol may transition to the martensite phase and the Nitinol wire may become plastic and able to deform. The elasticity of the lens base may be such that it will pull the Nitinol wire shape back to the as formed shape. The user may repeat the activation and deactivation process to change the lens between states. When the energy of the energy element is depleted, at some point the heating wire may not heat sufficiently to raise the temperature above the transition temperature. In such embodiments, when an energy source is depleted, the Nitinol may be stuck in the martensite phase and a shape of the lens may be determined based on the forces of an elastic nature of the contact lens body and the lens surface may flatten out. Thus, when deenergized, the lens may default to a far focal plane vision setting.

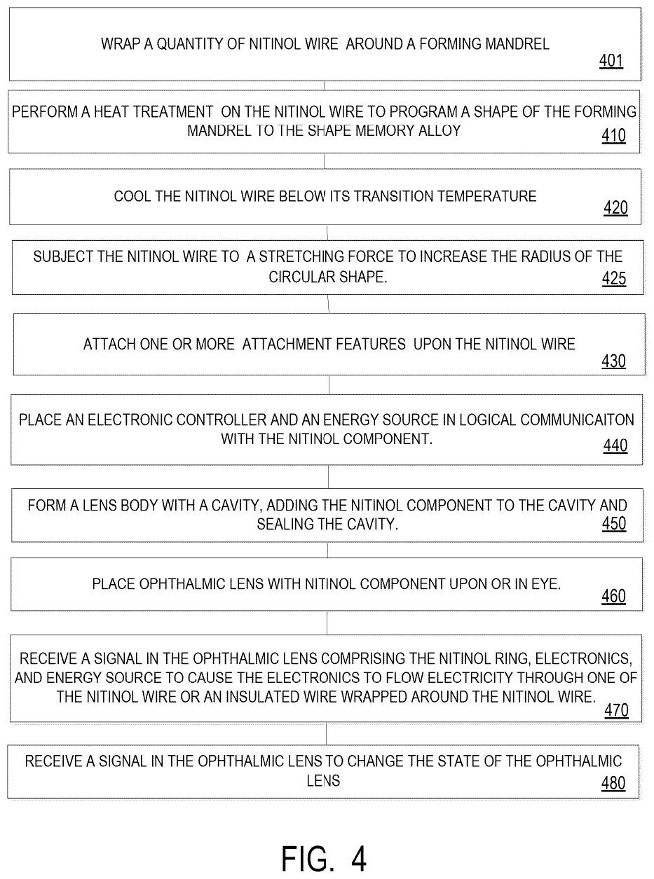

Referring to FIG. 4, an exemplary processing flow for an ophthalmic lens including a Nitinol ring element is found. At Step 401, a quantity of Nitinol wire is wrapped around a forming mandrel. In some examples, the forming mandrel may be shaped to form the wire into a circular shape. In some examples, a single strand of wire may be placed around the forming mandrel. In some examples, a preformed ring of wire may be placed where two ends of Nitinol may be welded together before being placed upon the mandrel. In other examples, a joining of two ends may be performed upon the mandrel. In still further examples, the Nitinol may be wrapped around the mandrel without sealing two ends, wherein the wire may be later cut, and the ends joined at a later time. The mandrel may have a circular shape or other shapes that, for example, may relate to a desire to add characteristics to address higher order optical aberrations than just a spherical shape. In some examples, wire may be wrapped around a number of mandrels at the same time. In some examples, fine Nitinol wire may be used and wrapped multiple times around each mandrel, such that the wire is a composite of multiple strands.

Proceeding to step 410, a heat treatment may be performed on the Nitinol wire. In some examples, the heat treatment may be performed in a controlled atmosphere such as in the absence of oxidizing or reducing elements including oxygen or hydrogen as non-limiting examples. Furthermore, the heat treatment may be performed with programmed ramping cycles. In some examples, the heat treatment may have a maximum temperature that is above 300 C. In some other examples, the heat treatment may have a maximum temperature that is 500 C. In further examples the heat treatment may have a maximum temperature at any value above 300 C. The heat treatment may occur for a time period of a few seconds.

In other examples the heat treatment may occur for any time period more than a few seconds. In some examples, the Nitinol wire may be subjected to a quenching or rapid cooling process. In some examples, a heat treatment of step 410 may program a shape into the Nitinol material, which is the shape of the Nitinol around the mandrel may be locked in as the shape that the austenite phase may assume when temperature of the Nitinol is ramped above the transition temperature by some manner.

Proceeding to step 420 the Nitinol wire may be cooled below its transition temperature, and then at step 425 the Nitinol wire may be subjected to a stretching force to increase the radius of the circular shape. The stretching may be performed by the mandrel that the Nitinol wire was formed upon. In other examples the Nitinol ring may be stretched with a second fixture. In some examples the Nitinol wire may be stretched into a shape other than a circle.

At step 430 a series of attachment features may be formed upon the Nitinol wire. In this step and subsequent steps, it may be important to maintain the Nitinol wire at a temperature beneath the transition temperature of the Nitinol wire during processing so that it does not change phase and accordingly shape.

At step 440 an electronic controller and an energy source may be added to the Nitinol component. In some examples, the electronic controller may be attached to two ends of the Nitinol wire so that current may be directed through the Nitinol wire itself to heat it above the transition temperature. In such examples, the wire ends may be joined at an insulator rather then being welded together. In another example a fine insulated wire may be wrapped around the Nitinol ring and the two ends may be connected to the electronic controller for heating. In some advanced examples, multiple wire pairs may be formed to allow for independent activation of segments of the rings.

At step 450, a lens body may be formed. In some examples, a cavity may be formed in the lens body and then the Nitinol wire component may be added to the cavity and sealed with a portion of a lens forming monomer mixture or other polymerizable material that may be polymerized by actinic radiation. Again, it may be important to maintain the temperature during any processing with the Nitinol element present at a temperature beneath the Nitinol alloy transition temperature.

At step 460, the Nitinol ring embedded in the contact lens, wherein the Nitinol exists below its transition temperature in a stretched state, is placed into the eye of a user.

At step 470, the contact lens including the Nitinol ring, electronics, and energy source may receive a signal which may be processed by the electronics and cause the electronics to flow electricity through one of the Nitinol wire or an insulated wire wrapped around the Nitinol wire. The flow of the electricity may cause the temperature of the Nitinol to rise above the transition temperature and change state to the programmed memory shape. In some examples, the ring may contract in diameter which may cause the contact lens material to bow up in the middle and cause the lens to focus on a nearer focal plane. In some examples the temperature may be maintained above the transition temperature at a constant temperature. The constant temperature may be maintained by measuring a temperature by sensing with a thermocouple or other temperature measurement device. In some other examples, the resistance of the wire used for heating (either the Nitinol or an insulating wrapped wire) may be measured by the electronics and used to determine the temperature. The feedback of the temperature may be used to hold the temperature above the transition temperature either by turning the heating on or off. In other examples, the current flowing through the wire may be controlled to maintain a temperature. In order to save energy, the temperature may be controlled to be as little above the transition temperature as possible.

At step 480, a signal may be transferred to the electronics to signal the electronics to change the state of the ophthalmic lens. The flow of current may be stopped in the wire, and the temperature may decrease to a temperature beneath the transition temperature of the Nitinol wire. When that happens the physical state of the Nitinol may transition to the martensite phase and the Nitinol wire may become plastic and able to deform. The elasticity of the lens base may be such that it will pull the Nitinol wire shape back to the as formed shape. The user may repeat the activation and deactivation process to change the lens between states. When the energy of the energy element is depleted at some point the heating wire may not heat sufficiently to raise the temperature above the transition temperature. In such embodiments, when an energy source is depleted, a Nitinol insert may remain in a martensite phase and a shape of the ophthalmic lens may be determined based on the forces of an elastic nature of a contact lens body and the lens surface may flatten out. In such embodiments, when deenergized, the ophthalmic lens may default to a far focal plane vision setting.

In some other examples, at steps 320 and 420 the Nitinol may be compressed after the temperature is lowered beneath the transition temperature. In these examples, an electrical current which heats the Nitinol component may cause it to resume an original shape that is expanded. In such a case the lens may be moved from an initial near focal plane to a far focal plane when activated. In these cases, when the energy source becomes deenergized, the lens may default to a near focal plane vision setting.

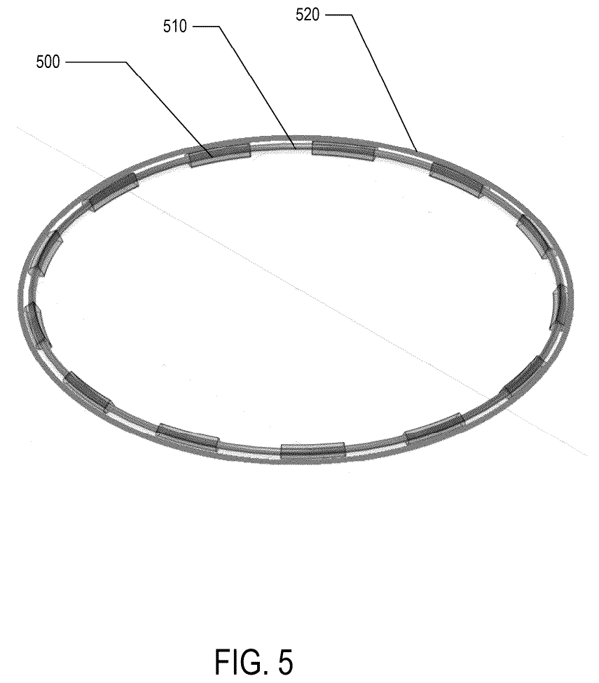

Referring to FIG. 5, in still further examples, a lens may be built with two Nitinol ring structures. A holding device 500, which may be very flexible and allow attached Nitinol rings to expand or contract may be connected to a first shape memory device, such as, for example, a first Nitinol ring 510 and a second Nitinol ring 520. As a non-limiting example, one of the Nitinol ring structure may be programmed with a shape that is larger than then the second Nitinol ring structure. In an example, the ring structures may be embedded in a contact lens body with enough distance between them so that when one of the ring structures is thermally activated, the other ring structure does not see a significant temperature rise.

A holding device 500 may hold the rings apart from each other and may also not conduct thermal energy through its body enough to significantly raise the temperature of one Nitinol ring structure when the other is heated. In this case, a user may activate a first ring which may be the ring programmed with the smaller diameter to shrink when heated. Thereafter, when the heating system of the first ring is turned off, it may cool below the transition temperature. If the body of the lens does not exert enough force to expand the first ring back to its initial state, then the second ring may be thermally activated.

A ring may be programmed (e.g.; formed or deformed) with a larger diameter such that when activated it pulls the first ring back to its original shape rapidly. In some examples, a combination of rings may allow for a lower energy consumption if a compressed state may either slowly or not at all return to its initial state after it cools below the transition temperature.

In some examples, the Nitinol structure may be formed from metal formed into a wire, from metal sheet forms, or from metal tube forms. In some other examples, a Nitinol additive manufacturing powder may be printed in a desired form and subsequently alloyed on an appropriate mandrel.

In some examples a lens according to the present disclosure may be part of a composite lens, which is a lens that has at least two discrete components. In a non-limiting example, a thin layer of hydrogel may contain features such as knife edges at its periphery and a cavity into which a lens element including Nitinol as has been described herein.

In some examples, wire may be wrapped around a mandrel to give it a shape and then heated to high temperature, such as over 500 C, to lock the “memory” of the shape memory alloy into the shape of the mandrel. The wire may be cut along an edge of the mandrel in an axial direction to free one or more loops of the “programmed” shape memory alloy. In some examples, the two ends of the loops may be joined. In some examples the joining may be by welding. In other examples a crimping device may hold both ends and be crimped into place. In other examples, holding structures or terminals may be formed around the wire and may hold the two ends as one of the locations that the holding structures are formed into.

In examples where the crimps or holding structures are insulators the two ends of the shape memory alloy may be connected to the electrical source for the wire to be heated by flowing current through it. In other examples, the shape memory alloy may have a different wire wrapped around it. A wrapped wire may be used to provide thermal energy to heat the shape memory alloy. As may be appreciated, when wires are wrapped around the shape memory alloy, segments of the shape memory alloy may have individual heating elements to allow for differential control of the shape memory alloy heating.

In some examples, when multiple segments are activated, but not a whole wire, for example, there may be shapes like a toric lens that are other than spherical. As mentioned previously, the shapes that are programmed into the shape memory alloys may also be formed to create a toric effect on the lens when activated. In examples with multiple shape memory alloy wires incorporated, each may have one or more heating elements to control a temperature of the shape memory alloy wire.

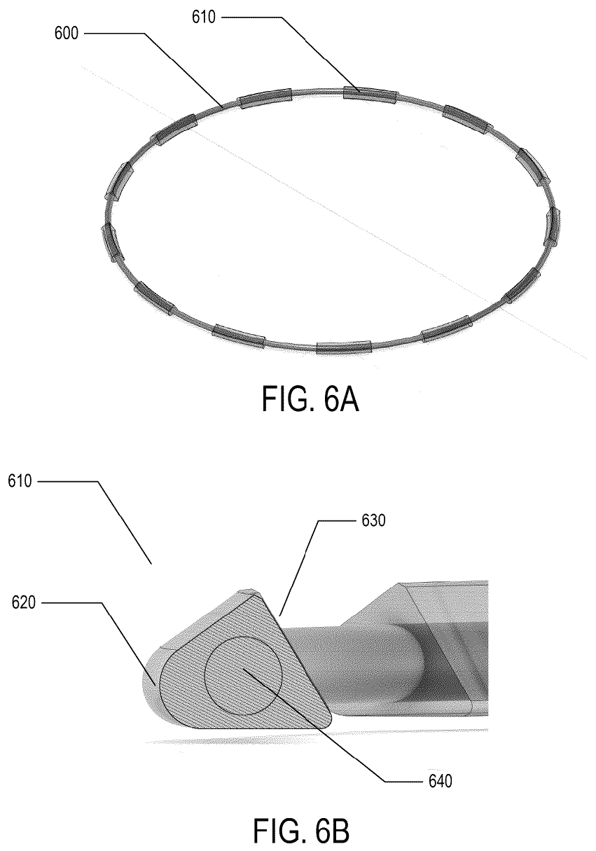

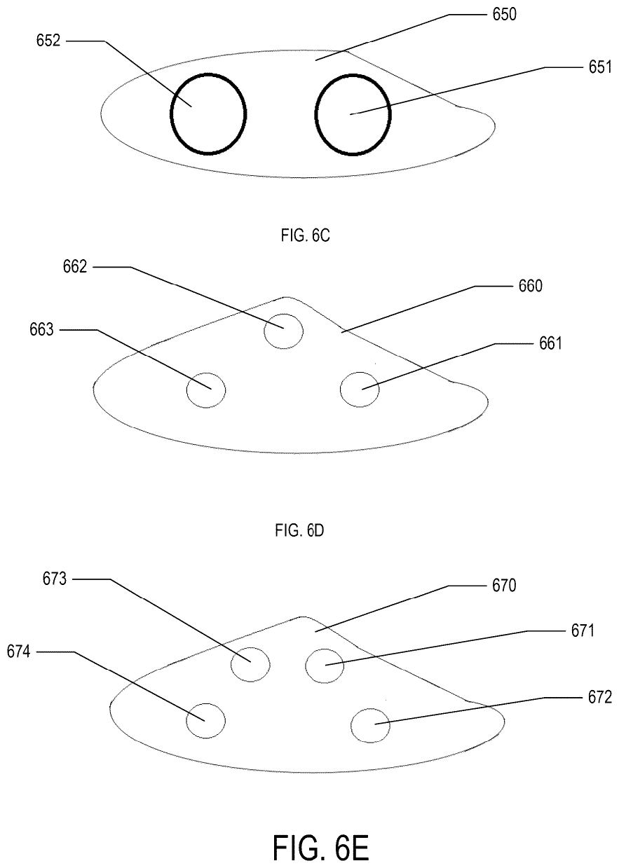

Referring to FIG. 6A, an exemplary single wire shape memory alloy structure is illustrated with a roughly circular wire structure 600 along with numerous holding devices such as holding structure 610. A non-limiting example of a holding device illustrated in cross section may be found in FIG. 6B. The holding structure 610 may be molded upon the shape memory device wire 640. The molding of the holding structure 610 may include element such as curved surfaces 620 to help limit any cutting potential as the shape memory alloy wire moves under the forces that occur as it is heated.

In some examples, portions of the holding device may have engineered surfaces at designed angles relative to the plane of the base of the ophthalmic device to help direct forces upon the lens body to move to create optical effects. Versions of the holding devices may include the ability to hold more than one wire.

Referring to FIG. 6C, an exemplary two wire cross section of a holding device is illustrated, with a first shape memory alloy wire 651, a second shape memory alloy wire 652 and a two wire holding feature 650.

Referring to FIG. 6D, an exemplary three wire cross section of a holding device 660 is illustrated with a first shape memory alloy wire 661, a second shape memory alloy wire 662, and a third shape memory alloy wire 663. In some examples, the wires may be deployed in regular geometric shapes such as triangles, squares, and the like. In other examples, the wires may be deployed to minimize cross talk of the thermal effects of heating one wire on neighboring wires. Referring to FIG. 6E an exemplary four wire cross section of a holding device 670 is illustrated with a first shape memory alloy wire 671, a second shape memory alloy wire 672, a third shape memory alloy wire 673, and a fourth shape memory alloy wire 674.

Numerous other embodiments with various numbers of wires are utilized or how to arrange a given number of wires. Different wires in an example may have different shapes programmed into them at high temperature and subsequently they may be stretched or compressed into different shapes at low temperatures before they are molded and incorporated into a lens structure.

### Characteristics of Nitinol and Other Shape Memory Alloys

Nitinol is a metal alloy including both nickel and titanium and may contain small amounts of other elements. Generally, the approximate ratio may be 40-50% nickel and 50-60% titanium. The varied ratios may cause a reproducible change in the transition temperature characteristics of the Nitinol stock. For example, a Nitinol alloy with a transition temperature of 40 C may be significantly higher than the average Cornea temperature which may be 34-35 C. Thus, minor variances in the temperature of the Cornea will not move an ophthalmic lens with embedded Nitinol structures to change state. In some examples, Nitinol stock with a transition temperature as high as 45 C may be utilized.

When the Nitinol structure has a programmed shape, in some examples, the Nitinol Structure may be stretched or compressed by a significant amount such as from 8-10%. In some examples, the range of change may be from 0-10%. In some working models, a change of 5% may be configured. There may be numerous shape memory alloys that may be used. Nitinol in particular has desirable hysteresis characteristics and may be formulated with compositions that have transition temperatures appropriate for ophthalmic applications.

### Ophthalmic Lens Formation by Addition Manufacture

An Ophthalmic lens body included in embodiments of the present invention may be formed using disparate methods and apparatus for forming a hydrogel ophthalmic lens, such as, for example, additive printing, lathing, stereolithography and/or cast molding. In a general sense, any method that may be used to generate a contact lens may be used to create a base that the shape memory alloy structure may be incorporated into and modify an optical characteristic of, is within the scope of the present invention.

A transition temperature of an included shape memory alloy may limit the methods of manufacture a hydrogel lens body containing the shape memory alloy. In some embodiments, methods of manufacture may be limited to relatively low temperature processes. Processes may include creation of a cavity within a lens hydrogel lens base to which a shape memory alloy structure may be added. The cavity may be sealed, encapsulating the shape memory alloy structure within the cavity. In a case where a lens is molded within a lens mold cavity, a shape memory alloy structure may be added, along with an energization element and controlling electronics to the lens mold cavity, and lens forming reactive monomer mixture may be added to the lens mold cavity and cured with actinic radiation.

In another type of example, an ophthalmic device may be formed according to the present disclosure by applying small droplets of polymerizable mixture to a surface based upon a pattern or map of energy transmissibility. A grayscale image may be used as a map of transmissibility of visible light energy. A surface may be a planar or arcuate surface. The droplets of polymerizable mixture applied to the surface may accumulate into a pattern of polymerizable mixture replicating the map of energy transmissibility. Following application of polymerizable mixture to the surface, the applied polymerizable mixture may be exposed to a limited amount of actinic conditions, such as radiation (limited in intensity and/duration) and/or thermal energy, to pin the applied polymerizable mixture into position. Polymerizable mixture that has been pinned may receive additional polymerizable mixture applied in a pattern of energy transmissibility. After a final application of polymerizable mixture, the polymerizable mixture accumulated on the substrate surface may be exposed to sufficient actinic radiation to cure the accumulated polymerizable mixture into a polymer. Hereto, a shape memory alloy may be programmed to a shape and then stretched or compressed into a shape that is consistent with the base status of the ophthalmic device. The additive manufacturing approach may also be used to first create a cavity into which the shape memory structure and associated energization element and controlling electronics may be added. The additive manufacturing technique may be used to seal the cavity in such examples.

An atmosphere encompassing droplets of polymerizable mixture during application onto the surface and during pendency on the surface prior to cure, may be carefully controlled in order to achieve a consistent optical quality of a device formed by the cured polymerizable mixture.

According to the present disclosure, in some embodiments, a polymerizable mixture is delivered in the form of extremely small droplets of typically 1-15 picolitre amounts at high velocities through a gaseous atmosphere with relatively high surface to volume ratios. A large number of droplets (estimated to be between 1.5 and 9 million) may be required to form a 25 milligram lens, such weight not including a shape memory device which may be added. In delivering each droplet to a proper place during manufacturing, several factors may be considered. The factors may include, but not limited to, one or more of: exposure of the droplet to ambient process conditions; a thickness of a resulting layer of material when the droplets impact a surface including one or both of a substrate and previously deposited polymerizable mixture; an interaction with a receiving surface including the substrate and/or previously deposited polymerizable mixture, such as wetting of the receiving substrate surface and merging with the previously deposited polymerizable mixture; effects of impinging droplets; an exposure time to actinic radiation and/or atmospheric gases between subsequent layers of droplets of polymerizable mixture; and curing/polymerization of deposited polymerizable mixture.

During the additive manufacturing process. there may be a significant opportunity for exposure of the polymerizable mixture to (and uptake of) an ambient gas, such as oxygen, from one or more of: an ambient process atmosphere (sometimes referred to as a controlled atmosphere); a receiving substrate surface; and previously deposited droplets of polymerizable mixture; if such factors are not accurately controlled, surface and bulk properties of a resulting ophthalmic lens (including optical properties) will be adversely affected.

The negative influence of oxygen is particularly acute in lenses produced using hydrogel materials such as 2-hydroxyethyl methacrylate (HEMA) or other monomers used in soft contact lenses and soft intraocular lenses. In these materials, variations caused by exposure to oxygen are more obvious in a final cured lens after the lens has absorbed water.

Typically, surface or skin portions of a lens formed with more oxygen present contain more polymer network defects than a bulk portion allowing more water to be absorbed in the areas formed with more oxygen present. The resulting distortion in these skin regions usually has a negative impact on the overall mechanical properties (modulus, tensile strength, elongation), optical properties (light transmission, refractive index etc.), shape, and part to part repeatability.

The present disclosure teaches control of and adjusting of an oxygen content of the polymerizable mixture in relation to the oxygen content of the controlled atmosphere (as described herein) in order for the effects of oxygen to be controlled to an extent that the properties of an optical element formed are not significantly impacted.

In those embodiments that include the formation of ophthalmic devices, (e.g., contact lenses and intraocular lenses), the ability to create an optical prescription is highly dependent on precise shapes of curved surfaces. Producing these required surfaces on these and other non-ophthalmic optical elements can be achieved by using the principles described herein, thus enabling the benefits of using 3D deposition printing such as simplicity, efficiency, more degrees of freedom in design, lower time requirements, and costs.

### Energized Ophthalmic Lens Devices

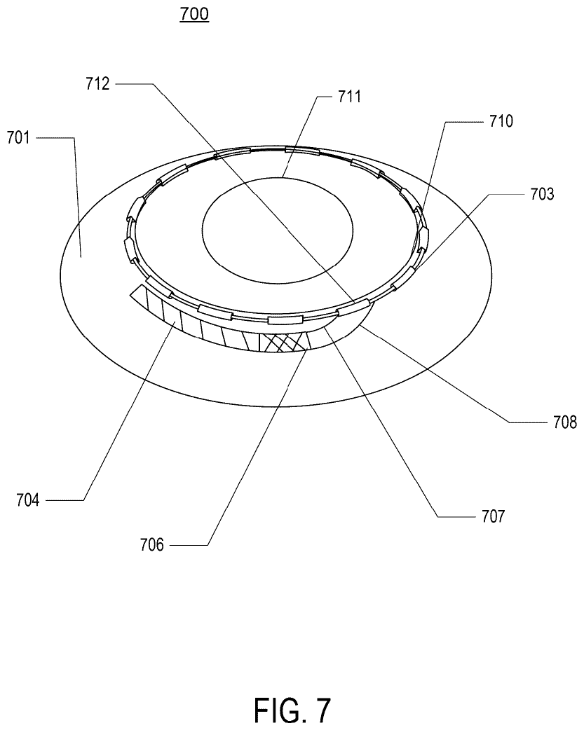

Referring now to FIG. 7, an example of an energized lens 700 may include a hydrogel based ophthalmic lens 701 (or other lens material) with an optic zone 711. According to the present invention, one or more optical characteristics of the optic zone 711 may be modified via changing a shape of an embedded electroactive shape memory alloy structure 710. The shape of the embedded electroactive shape memory alloy structure 710 may be modified via a change in temperature that may be caused (in some embodiments) as a result of applied electric current across a first wire 707, and a second wire 708, in electrical communication with the electroactive shape memory alloy structure 710.

In some embodiments, an energy source 704 is placed in electrical communication with controlling electronics 705 and a communications device 706 to supply electrical power to the controlling communications and communications device 706. Electrical power may be supplied, for example, via at least, a first power conductor 707 and a second conductor 708.

In some embodiments, the electroactive shape memory alloy structure 710 may be supported in the hydrogel based ophthalmic lens 701 with one or more holding structures 703 (as described in further detail in reference to FIG. 6).

One or more energy sources 704 that are functional to supply electrical power to one or more of: the electroactive shape memory alloy structure 710, electronic components, and communication devices, may include one or more of: an electrochemical cell or battery as the storage means for the energy. The energy source 704 may be encapsulated or otherwise isolated from the hydrogel material in the hydrogel based ophthalmic lens 701.

Some specific embodiments may include a lithium ion battery as an energy source 704. Lithium ion batteries are generally rechargeable. According to the present invention, the lithium ion battery is in electrical communication with a charging device and also a power management circuit, both of which may be embedded within the lens, or external, such as, for example via wireless conduction. In some examples, when two shape memory alloy wires are employed, energy may be conserved if one wire's programmed shape is one of a bistate device and the other wire is programmed to the other shape.

In some such examples, energy may be used to activate the shape memory alloy wires individually and after changing the state, the heating may be discontinued while the lens device maintains the configuration related to the last activated shape memory alloy wire. In some other examples, where the forces of the holding features, lens body and the second shape memory alloy cause the energized shape to be pulled back over time, the temperature may be maintained in the wire that activates the near focus state. Thus, when the energy device is depleted, the lens may default to a far focal state.

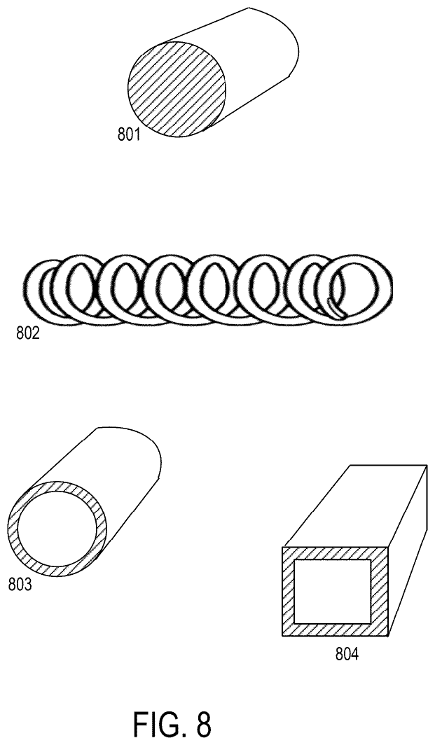

Referring now to FIG. 8, in this disclosure the term “wire” has been used to refer to an item of Nitinol that may be embedded in an ophthalmic lens. As used herein, a “wire” may refer to an article with various different physical shapes and mass. For example, a wire may include a length of solid material with a generally circular cross section 801, a wire may also include a coil of Nitinol material 802. A structure may include a length of Nitinol formed with a hollow interior (or an interior portion fashioned from a material other than Nitinol, such as for example a gold, silver, or copper solid wire). Examples of an item with a generally circular cross section with a hollow interior include a generally circular cross section interior 803, and an item with a generally square or rectangular interior 804.

### Glossary of Selected Terms

Reference may have been made to different aspects of some preferred embodiments of the invention, examples of which are illustrated in the accompanying drawings. A Glossary of Selected Terms is included for various terms which may be used for which the following definitions will apply:

“Actinic Radiation” as used herein, refers to emission of energy that is capable of initiating a chemical reaction in an associated Polymerizable Mixture. In some embodiments, actinic radiation includes radiation with a wavelength in a range of 280-450 nm. In some more specific examples embodiments, an actinic radiation corresponding to UVA and blue light includes an energy with a wavelength in the range of 315-450 nm, some preferred embodiments include energy in the 365 nm to 400 nm range.

“Addition Based Manufacture” (sometimes referred to herein as “additive manufacturing” means a process during which units of material are added to a structure being formed via the aggregation of the units of material into a shape.

“Arcuate” as used herein, refers to a geometric shape including a curved surface.

“Cure” as used herein refers to expose a polymerizable mixture to Fixing Radiation of sufficient intensity and for a sufficient duration of time to crosslink a majority of Polymerizable mixture.

“Electroactive” as used herein is an adjective describing a material that changes shape or is otherwise responsive to an electrical field.

“Energized” as used herein, refers to the state of being able to supply electrical current to or to have electrical energy stored within.

“Energized Ophthalmic Lens” as used herein, refers to an energized ophthalmic lens refers to an ophthalmic lens with an energy source added onto or embedded within the formed lens.

“Energy” as used herein, refers to the capacity of a physical system to perform work. Many uses within this invention may relate to said capacity being able to perform electrical actions in doing work.

“Energy Source” as used herein, refers to a device capable of supplying Energy or placing a biomedical device in an Energized state.

“Energy Harvesters” as used herein, refers to a device capable of extracting energy from the environment and converting it to electrical energy.

“Fixing Radiation” as used herein, refers to Actinic Radiation of appropriate wavelength, and sufficient intensity and duration to crosslink a majority of Polymerizable mixture exposed to the Fixing Radiation.

“Gelling” or “Gelation” as used herein, refers to a degree of polymerization sufficient to stop or substantially slow a movement of polymerizable mixture deposited on a receiving surface while allowing subsequent droplets to meld with previously deposited polymerizable mixture and form a structure with a single mass of polymerizable mixture without distortion. Gelled PM moves to a higher viscosity state, but stops short of full cure, pinning or gelation (or gelling) enhances the management of flow and form, and provides a high quality surface.

“Gel Point” as used herein shall refer to a point in a polymerization process at which a gel or insoluble fraction is formed. Gel point may be considered the extent of conversion at which the liquid polymerization mixture becomes a high viscous material that is immobile on a stationary surface. Gel point can be determined, for example, using a Soxhlet experiment: Polymer reaction is stopped at different time points and the resulting polymer is analyzed to determine the weight fraction of residual insoluble polymer. The data can be extrapolated to the point where no gel is present. This point where no gel is present is the gel point. The gel point may also be determined by analyzing the viscosity of a polymerizable mixture during a reaction. The viscosity can be measured using a parallel plate rheometer, with the polymerizable mixture between the plates. At least one plate should be transparent to radiation at the wavelength used for polymerization. The point at which the viscosity approaches infinity is the gel point. Gel point occurs at the same degree of conversion for a given polymer system and specified reaction conditions.

“Inhibitor” as used herein refers to a chemical reactant or process that slows or halts a chemical reaction.

“Initiator” as used herein refers to a substance that initiates a chain reaction or polymerization.

“Intensity” as used herein refers to an amount of power transferred per unit area, where the area is measured on a plane perpendicular to a direction of propagation of the energy (e.g., watts per square meter (W/m2)).

“Lens” as used herein “lens” as used herein refers to any ophthalmic device that resides in or on the eye. These devices can provide optical correction or may be cosmetic. For example, the term lens can refer to a contact lens, intraocular lens, overlay lens, ocular insert, optical insert, or other similar device through which vision is corrected or modified, or through which eye physiology is cosmetically enhanced (e.g., iris color) without impeding vision.

“Lens Forming Mixture” as used herein, refers to the term “lens forming mixture” or “Reactive Mixture” or “RMM” (reactive monomer mixture) refers to a monomer or prepolymer material which can be cured and crosslinked or crosslinked to form an ophthalmic lens. Various embodiments can include lens forming mixtures with one or more additives such as: UV blockers, tints, photoinitiators or catalysts, and other additives one might desire in an ophthalmic lenses such as, contact or intraocular lenses.

“Lithium Ion Cell” as used herein refers to an electrochemical cell where Lithium ions move through the cell to generate electrical energy. This electrochemical cell, typically called a battery, may be reenergized or recharged in its typical forms.

“Pinning” as used herein refers to the application of actinic conditions, such as exposure to limited actinic radiation, to a polymerizable mixture in an amount sufficient to perform a gelation process or gelling, but not cause the PM to cure.

“Polymerizable Mixture” (sometimes referred to as “PM”) as used herein, refers to a liquid mixture of components (reactive and possibly also non-reactive components) which upon exposure to an external energy (e.g., actinic radiation in a range of 280-450 nm (e.g., UV-light or blue light or heat) is capable of undergoing polymerization to form a polymer or polymer network. A polymerizable mixture may include a monomer or prepolymer material which can be cured and/or crosslinked to form an ophthalmic lens or modify an existing lens or lens blank. Various embodiments can include Polymerizable mixtures with one or more additives such as: UV blockers, bonding agents, tints, photo initiators or catalysts, and other additives one might desire in an ophthalmic lenses such as, contact or intraocular lenses. In some embodiments, a Polymerizable mixture may also be a Hydrogel Precursor.

Power: Work done, or energy transferred per unit of time.

Rechargeable or Re-energizable: Capable of being restored to a state with higher capacity to do work. Many uses within this invention may relate to the capability of being restored with the ability to flow electrical current at a certain rate for a certain, reestablished time period.

Reenergize or Recharge: To restore to a state with higher capacity to do work. Many uses within this invention may relate to restoring a device to the capability to flow electrical current at a certain rate for a certain, reestablished time period.

While the invention has been described in conjunction with specific embodiments, it is evident that many alternatives, modifications, and variations will be apparent to those skilled in the art in light of the foregoing description. Accordingly, this description is intended to embrace all such alternatives, modifications and variations as fall within its spirit and scope.

What is claimed is:

1. An electroactive ophthalmic lens comprising:
a. a hydrogel mass of a size and shape for placing on an eye of a patient, the hydrogel mass comprising an optic zone with an optical characteristic for modifying vision of the patient;
b. a shape memory alloy structure supported in the hydrogel mass outside of the optic zone; and
c. a power source in electrical communication with the shape memory alloy structure.

2. The electroactive ophthalmic lens of claim 1, additionally comprising a holding structure supporting the shape memory alloy structure within the hydrogel mass outside of the optic zone.

3. The electroactive ophthalmic lens of claim 2, wherein the power source is capable of supplying sufficient power to the shape memory alloy structure to cause the shape memory alloy structure to change state.

4. The electroactive ophthalmic lens of claim 1, additionally comprising control electronics operative to cause the power source to supply power to the shape memory alloy structure.

5. The electroactive ophthalmic lens of claim 4, additionally comprising a communications device operative to wirelessly receive a command to have the control electronics operative cause the power source to supply power to the shape memory alloy structure.

6. The electroactive ophthalmic lens of claim 5, additionally comprising a first power conductor placing the power source in electrical communication with the shape memory alloy structure.

7. The electroactive ophthalmic lens of claim 6, additionally comprising a second power conductor placing the power source in electrical communication with the shape memory alloy structure.

8. The electroactive ophthalmic lens of claim 1 wherein the shape memory alloy structure comprises a first wire comprising nitinol.

9. The electroactive ophthalmic lens of claim 8 where the shape memory alloy structure comprises at least a second wire comprising nitinol with a difference of one or more of size or shape compared with the first wire comprising nitinol.

10. A method of forming an electroactive ophthalmic lens, the method comprising steps of:
a. forming a shape memory alloy structure insert with a size and shape capable of being embedded in a contact lens without obscuring an optic zone of an ophthalmic lens;
b. fixedly attaching multiple holding structures to the shape memory alloy structure insert;
c. placing the shape memory alloy structure insert in electrical communication with a power source; and
d. embedding the shape memory alloy structure insert, the holding structures, and the power source within hydrogel comprising the ophthalmic lens.

11. The method of claim 10 additionally comprising a step of embedding an electronic controller within the hydrogel comprising the ophthalmic lens, the electronic controller operative to cause the power source to supply electrical power to the shape memory alloy structure insert.

12. The method of claim 11 additionally comprising a step of embedding a communications device in the hydrogel comprising the ophthalmic lens, the communications device operative to receive a wireless communication comprising a command to operate the electronic controller to cause the power source to supply electrical power to the shape memory alloy structure insert.

13. The method of claim 10 wherein the shape memory alloy structure insert comprises a first wire comprising nitinol.

14. The method of claim 13 wherein the shape memory alloy structure insert comprises at least a second wire comprising nitinol with a difference of one or more of size or shape compared with the first wire comprising nitinol.

15. A method of forming an ophthalmic lens, the method comprising steps of:
a. wrapping a quantity of a shape memory alloy wire around a forming mandrel;
b. performing a heat treatment on the nitinol wire to program a shape of the forming mandrel to the shape memory alloy wire;
c. cooling the shape memory alloy wire below a transition temperature of the shape memory alloy wire;
d. stretching the shape memory alloy wire;
e. attaching one or more attachment features upon the shape memory alloy wire;
f. forming a lens body with a cavity;
g. placing the shape memory alloy wire within the cavity of the lens body; and
h. sealing the cavity to form the ophthalmic lens.

16. The method of claim 15 wherein the shape memory allow is comprised of nitinol.

17. The method of claim 15 further comprising placing an electronic controller and an energy source in logical communication with the shape memory alloy wire.

18. The method of claim 17 further comprising receiving a signal in the ophthalmic lens comprising the shape memory alloy wire, the electronic controller, and the energy source, wherein the receiving of the signal causes the electronic controller to flow electricity through one of the shape memory allow wire or an insulated wire wrapped around the shape memory allow wire.

19. The method of claim 18 wherein the flow of electricity heats the shape memory alloy wire and causes a change in an optical state of the ophthalmic lens.

20. The method of claim 15 further comprising placing at least a second heat treated shape memory alloy wire within the cavity of the lens body.
